(19) United States
(12) Patent Application Publication
(10) Pub. No.: US 2014/0089401 A1
(43) Pub. Date: Mar. 27, 2014

(54) SYSTEM AND METHOD FOR CAMERA PHOTO ANALYTICS

(71) Applicant: GOOGLE INC., Mountain View, CA (US)

(72) Inventors: Momchil Filev, Mountain View, CA (US); Martin Brandt Freund, Mountain View, CA (US)

(73) Assignee: GOOGLE INC., Mountain View, CA (US)

(21) Appl. No.: 13/625,809

(22) Filed: Sep. 24, 2012

(51) Int. Cl. G06F 17/30; G06F 15/16

(52) U.S. Cl. 709/204

(57) ABSTRACT

A system and method for generating one or more statistics related to a photo. The system and method include collecting information describing circumstances of an event resulting in creation of a first photo taken by a camera; associating the information with the first photo, where the information includes attributes of an image included in the first photo and the camera; analyzing the information with respect to social networking information stored in one or more databases; and identifying one or more other photos related to the first photo based on results of the analysis.

### BACKGROUND

In conventional systems, capturing a photo with a camera is not an information-rich event. Very little information about the captured photo can be discerned at the camera device. In addition, most cameras (e.g., point-and-shoot cameras and digital SLR (single-lens reflex) cameras) do not have a network connection. Therefore, the photo cannot be immediately shared with others, making capturing the photo an isolated event.

Capturing photos with mobile devices that are equipped with a camera is becoming more popular, in part due to the ability to share the photo with others immediately after the photo is taken. Photos can be shared with others via email, text message, and/or social networking service, for example.

### SUMMARY

One embodiment provides a method for generating one or more statistics related to a photo. The method includes collecting information describing circumstances of an event resulting in creation of a first photo taken by a camera; associating the information with the first photo, wherein the information includes attributes of an image included in the first photo and the camera; analyzing the information with respect to social networking information stored in one or more databases; and identifying one or more other photos related to the first photo based on results of the analysis.

Another embodiment includes a method for receiving one or more statistics related to a photo. The method includes: capturing a first photo with a camera; generating metadata corresponding to the first photo; transmitting the first photo and the metadata to a server that includes an analytics engine; and receiving, from the server, statistical information related to the first photo, wherein the statistical information is generated based on the analytics engine analyzing the first photo and the metadata with respect to social networking information stored in a database.

Yet another embodiment includes a system for generating a statistic about a photo, comprising: one or more databases storing photos and social networking data; a mobile phone that includes a camera configured to take a first photo; a server in communication with the mobile phone via a data network configured to: receive the first photo taken by the camera; receive metadata corresponding to the first photo and device information corresponding to the mobile phone; analyze the first photo, the metadata, and the device information with respect to the social networking data stored in the one or more databases; and identify one or more photos related to the first photo based on analyzing the first photo, the metadata, and the device information.

### BRIEF DESCRIPTION OF THE DRAWINGS

FIG. 1 is a block diagram of an example system for generating photo analytics, according to an example embodiment.

FIG. 2 is a block diagram of the arrangement of components of a client device configured to receive photo analytics, according to one embodiment.

FIG. 3 is a block diagram of example functional components for a client device, according to one embodiment.

FIG. 4 is a flow diagram for generating one or more photo analytics, according to an example embodiment.

FIG. 5 is a flow diagram for generating one or more photo recommendations, according to an example embodiment.

FIG. 6 is a flow diagram for updating photo analytics settings, according to an example embodiment.

FIGS. 7A-7B are conceptual diagrams illustrating a user interface for presenting one or more analytics about a photo, according to an example embodiment.

FIGS. 8A-8B are conceptual diagrams illustrating a user interface for presenting one or more recommendations associated with a photo, according to an example embodiment.

### DETAILED DESCRIPTION OF EXAMPLES

The present disclosure relates to making photo-taking a more interactive and social experience. According to various embodiments, when a client device, such as a mobile phone, takes a photo, the photo and certain metadata about the photo is uploaded to a server. Examples of metadata include GPS (global positioning system) location information about where the photo is taken, orientation/directional information, camera make/model, orientation of the camera (i.e., horizontal/vertical), date/time of the photo, weather data (e.g., sunset/sunrise info, direction of light, weather conditions) at the time the photo is taken, post-processing filters applied to the photo, contrast, brightness, flash ON/OFF, exposure level, number of faces in the photo, among others.

In addition, a device identifier (ID) corresponding to the client device taking the photo is uploaded to the server. The device ID can be used to identify a user that captured the photo, where each device ID corresponds to a particular user. The server can also search a social network database for photos taken by friends of the user and/or other publicly-available photos that are related to the photo currently being taken by the client device. Examples of social networking information may include users that are friends with or in social networking circles with the user, what other pictures the related users have taken that are similar to the current photo being taken, what other photos did the related users take just before and just after the related photo, and user tags within the related photos, among others.

The photo, the metadata, and the social information are analyzed by an analytics engine at the server. The server generates statistical information about the photo. The statistics are then communicated above to the user, in real-time.

Examples of statistics include: how many other people have taken a photo in this location (and what were their demographics, age, gender, interests, etc.), which people in the user's circles or contacts lists have taken a photo in this location, if there are people in the user's circles that have taken photos here: who were they with, when were they here, what were their photos like (e.g., with an option to access the photos if they have been made public), what were other similar photo locations of people who took photos here (e.g., either all users or just people in the user's circles), what were the preferred camera settings of people who took a photo in this location, what was the preferred photo orientation of people who took a photo in this location, what was the most common time of day that users took a photo in this location, etc.

The analytics engine may also provide the user with an option and/or recommendation, displayed via a user interface, to take a similar photo as that taken by one or more other users. For example, if several other users have applied a particular filter to a photo taken at the same location, the user may be given the option to apply that filter. Also, the analytics engine may provide the user with instructions on how to take similar photos to those taken by others. For example, if many users have taken a photo from a location 500 feet further to the east from the current location and at a time when the sun was in a particular location in the sky, the analytics engine may provide the user with instructions on how to move to the particular location and how much time the user has to wait until the sun is in the same position as in the photos of the other users.

In some embodiments, users may have privacy settings/options of whether their photos should be included in the analysis performed by the analytics engine and/or which metadata about their photos should be included in the analysis performed by the analytics engine.

In some embodiment, the analytics engine is configured to filter out certain types of photos and not perform the analysis. For example, the analytics engine may be configured to perform an analysis on photos taken when users are sightseeing or traveling and want to discover other photo locations, but the analytics engine may be configured not to perform an analysis when the user is just taking a casual picture, e.g., at a party or at a social event (i.e., user does not want to be inundated with a stream of statistics for every picture taken).

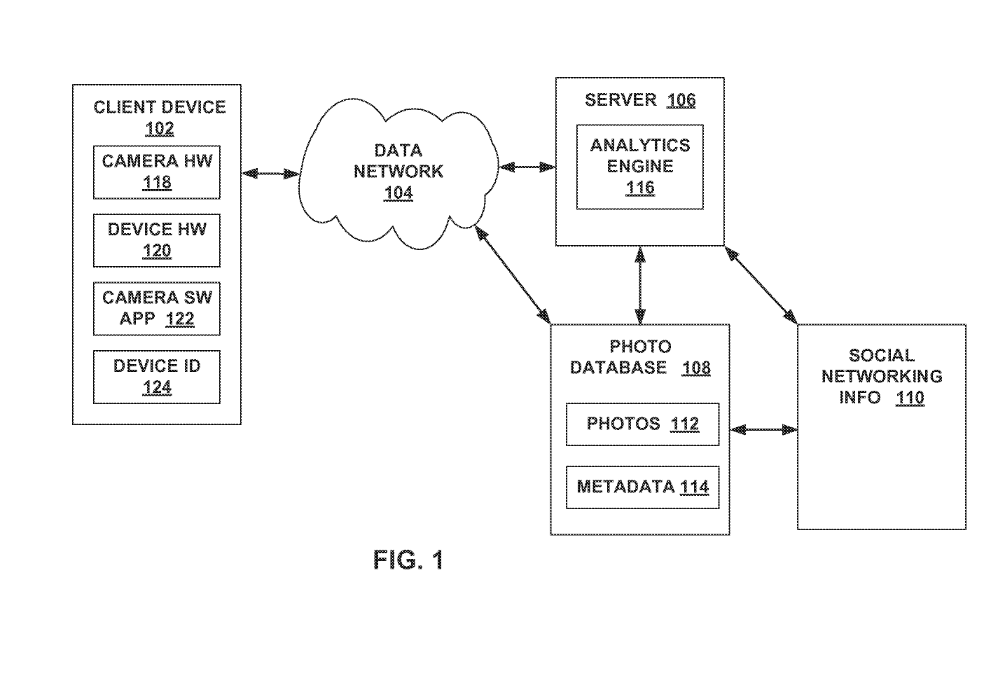

FIG. 1 is a block diagram of an example system for generating photo analytics, according to an example embodiment. The system includes a client device 102, a data network 104, a server 106, a photo database 108, and social networking information 110.

The client device 102 can be any type of computing device, including a personal computer, laptop computer, mobile phone with computing capabilities, or any other type of device capable of making a voice call. The client device 102 includes, among other things, camera hardware 118, device hardware 120, camera software or application 122, a device identifier (ID) 124, other application(s), a communications client, output devices (e.g., a display), and input devices (e.g., keyboard, mouse, touch screen), etc. In some embodiments, a client device 202 may act as both an output device and an input device.

The camera hardware 118 includes picture-taking components, such as a digital sensor, a lens, a flash, among others. Device hardware 120 includes components capable of detecting and/or measuring real-world phenomena at the client device, e.g., a GPS (global positioning system) module, an accelerometer, a compass, and/or a light intensity sensor. The camera software application 122 allows a user to capture a photo at the client device 102 using the camera hardware 118. According to various embodiments, the camera software application 122 can be implemented in the OS (operating system) of the client device 102 or as a stand-alone application installed on the client device 102. The device ID 124 is a unique identifier corresponding to the client device 102. In some embodiments, the device ID 124 also corresponds to a particular user.

The data network 104 can be any type of communications network, including an Internet network (e.g., wide area network (WAN) or local area network (LAN)), wired or wireless network, or mobile phone data network, among others.

The client device 102 is configured to communicate with a server 106 via the data network 104. The server 106 includes an analytics engine 116. The server 106 is in communication with a photo database 108 and social networking information 110. In some embodiments, the photo database 108 can also communicate with a server that stores the social networking information 110.

The photo database 108 stores photos 112 and metadata 114 corresponding to the photos. For a particular photo, some examples of metadata 114 include: a GPS location of the photo, a direction (i.e., compass information) of the photo, a device ID of the device taking the photo, camera make and/or model of the photo, an orientation (i.e., horizontal, vertical) of the photo, a date and time of the photo, weather information (e.g., sunset/sunrise information at a particular location and time, direction of light, and/or weather conditions (e.g., sun, rain, snow, etc.)), filters applied to the photo, other post-processing performed on the photo, contrast, brightness, exposure level, incandescence, fluorescence, scene mode, whether flash was ON/OFF, a number of faces in the photo, a number of re-takes made of this photo, and/or a reference to one or more related photos. In some embodiments, the client device 102 is configured to communicate with the photo database 108 via the data network 104.

As described in greater detail herein, a photo can be captured at the client device 102 and uploaded to the photo database 108 via the data network 104. The photo is also transmitted to the server 106 that includes the analytics engine 116. The analytics engine 116 analyzes the photo, as well as one or more other photos in the photo database 108, and/or social networking information 110 to identify one or more statistics and/or analytical information corresponding to the photo. The statistics or analytical information are then aggregated and delivered to the client device 102 and displayed on the client device. In some embodiments, the statistics or analytical information provide information about other users that have taken similar photos and/or recommendations of other photos and/or camera settings to be used by the client device 102 when taking photos.

In some embodiments, the server 106, photo database 108, and social networking information 110 comprise a single server. According to various embodiments, the server 106, photo database 108, and social networking information 110 can be physically separate machines or can be different processes running within the same physical machine. In some embodiments, as described below, the user may set various privacy controls related to the storage of the photos 112 and/or metadata 114 in the photo database 108. Examples include anonymization of device identifiers and/or ability for a user to modify or delete which information related to the user's photos is available to the analytics engine 116.

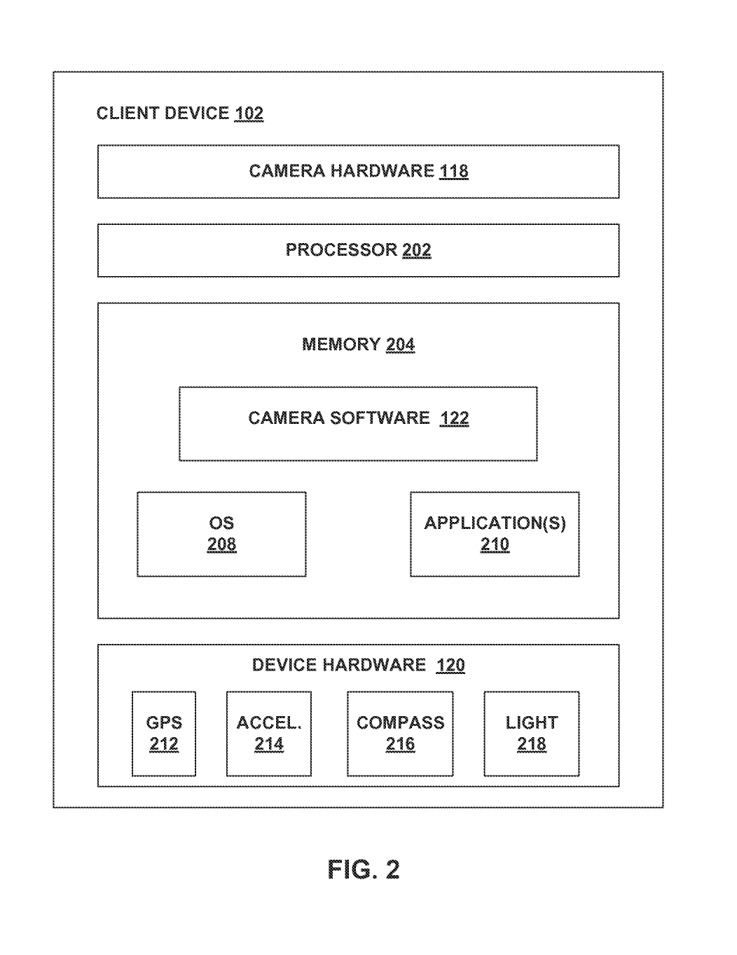

FIG. 2 is a block diagram of the arrangement of components of a client device 102 configured to receive photo analytics from a server, according to one embodiment. As shown, client device 102 includes camera hardware 118, device hardware 120, a processor 202, and memory 204, among other components (not shown). The device hardware 120 includes, for example, a GPS module 212, an accelerometer 214, a compass 216, and a light sensor 218.

The memory 204 includes various applications that are executed by processor 202, including installed applications 210, an operating system 208, and camera software 122. For example, installed applications 210 may be downloaded and installed from an applications store.

As described, the camera software 122 is configured to upload a photo captured by the camera hardware 118 and associated metadata to a photo database 108 and/or server 106. As described herein, the analytics engine 116 on the server 106 is configured to access the photo and the metadata and perform analysis to identify one or more statistics, analytics, and/or recommendations related to the photo. The one or more statistics, analytics, and/or recommendations are then communicated from the server 106 to the camera software 122 and displayed on the client device 102.

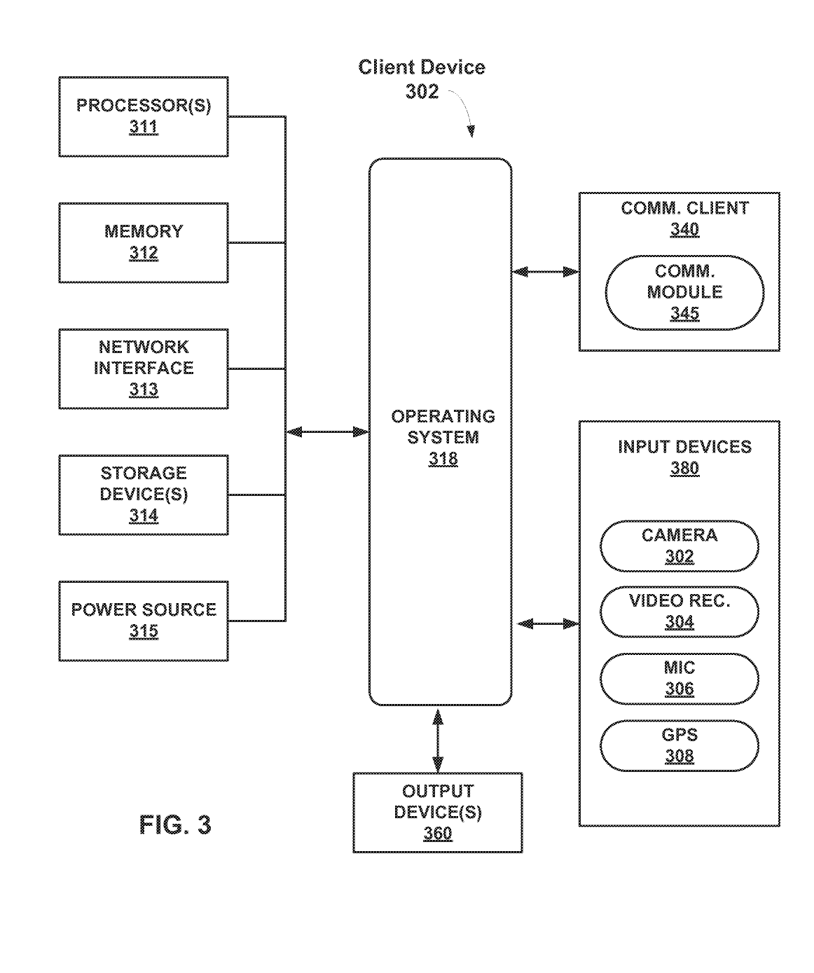

FIG. 3 is a block diagram of example functional components for a client device 302, according to one embodiment. One particular example of client device 302 is illustrated. Many other embodiments of the client device 302 may be used. In the illustrated embodiment of FIG. 3, the client device 302 includes one or more processor(s) 311, memory 312, a network interface 313, one or more storage devices 314, a power source 315, output device(s) 360, and input device(s) 380. The client device 302 also includes an operating system 318 and a communications client 340 that are executable by the client. Each of components 311, 312, 313, 314, 315, 360, 380, 318, and 340 is interconnected physically, communicatively, and/or operatively for inter-component communications in any operative manner.

As illustrated, processor(s) 311 are configured to implement functionality and/or process instructions for execution within client device 302. For example, processor(s) 311 execute instructions stored in memory 312 or instructions stored on storage devices 314. Memory 312, which may be a non-transient, computer-readable storage medium, is configured to store information within client device 302 during operation. In some embodiments, memory 312 includes a temporary memory, area for information not to be maintained when the client device 302 is turned OFF. Examples of such temporary memory include volatile memories such as random access memories (RAM), dynamic random access memories (DRAM), and static random access memories (SRAM). Memory 312 maintains program instructions for execution by the processor(s) 311.

Storage devices 314 also include one or more non-transient computer-readable storage media. Storage devices 314 are generally configured to store larger amounts of information than memory 312. Storage devices 314 may further be configured for long-term storage of information. In some examples, storage devices 314 include non-volatile storage elements. Non-limiting examples of non-volatile storage elements include magnetic hard disks, optical discs, floppy discs, flash memories, or forms of electrically programmable memories (EPROM) or electrically erasable and programmable (EEPROM) memories.

The client device 302 uses network interface 313 to communicate with external devices via one or more networks, such server 106 and/or photo database 108 shown in FIG. 1. Network interface 313 may be a network interface card, such as an Ethernet card, an optical transceiver, a radio frequency transceiver, or any other type of device that can send and receive information. Other non-limiting examples of network interfaces include wireless network interface, Bluetooth®, 3G and WiFi® radios in mobile computing devices, and USB (Universal Serial Bus). In some embodiments, the client device 302 uses network interface 313 to wirelessly communicate with an external device, a mobile phone of another, or other networked computing device.

The client device 302 includes one or more input devices 380. Input devices 380 are configured to receive input from a user through tactile, audio, video, or other sensing feedback. Non-limiting examples of input devices 380 include a presence-sensitive screen, a mouse, a keyboard, a voice responsive system, camera 302, a video recorder 304, a microphone 306, a GPS module 308, or any other type of device for detecting a command from a user or sensing the environment. In some examples, a presence-sensitive screen includes a touch-sensitive screen.

One or more output devices 360 are also included in client device 302. Output devices 360 are configured to provide output to a user using tactile, audio, and/or video stimuli. Output devices 360 may include a display screen (part of the presence-sensitive screen), a sound card, a video graphics adapter card, or any other type of device for converting a signal into an appropriate form understandable to humans or machines. Additional examples of output device 360 include a speaker, a cathode ray tube (CRT) monitor, a liquid crystal display (LCD), or any other type of device that can generate intelligible output to a user. In some embodiments, a device may act as both an input device and an output device.

The client device 302 includes one or more power sources 315 to provide power to the client device 302. Non-limiting examples of power source 315 include single-use power sources, rechargeable power sources, and/or power sources developed from nickel-cadmium, lithium-ion, or other suitable material.

The client device 302 includes an operating system 318, such as the Android® operating system. The operating system 318 controls operations of the components of the client device 302. For example, the operating system 318 facilitates the interaction of communications client 340 with processors 311, memory 312, network interface 313, storage device(s) 314, input device 180, output device 160, and power source 315.

As also illustrated in FIG. 3, the client device 302 includes communications client 340. Communications client 340 includes communications module 345. Each of communications client 340 and communications module 345 includes program instructions and/or data that are executable by the client device 302. For example, in one embodiment, communications module 345 includes instructions causing the communications client 340 executing on the client device 302 to perform one or more of the operations and actions described in the present disclosure. In some embodiments, communications client 340 and/or communications module 345 form a part of operating system 318 executing on the client device 302.

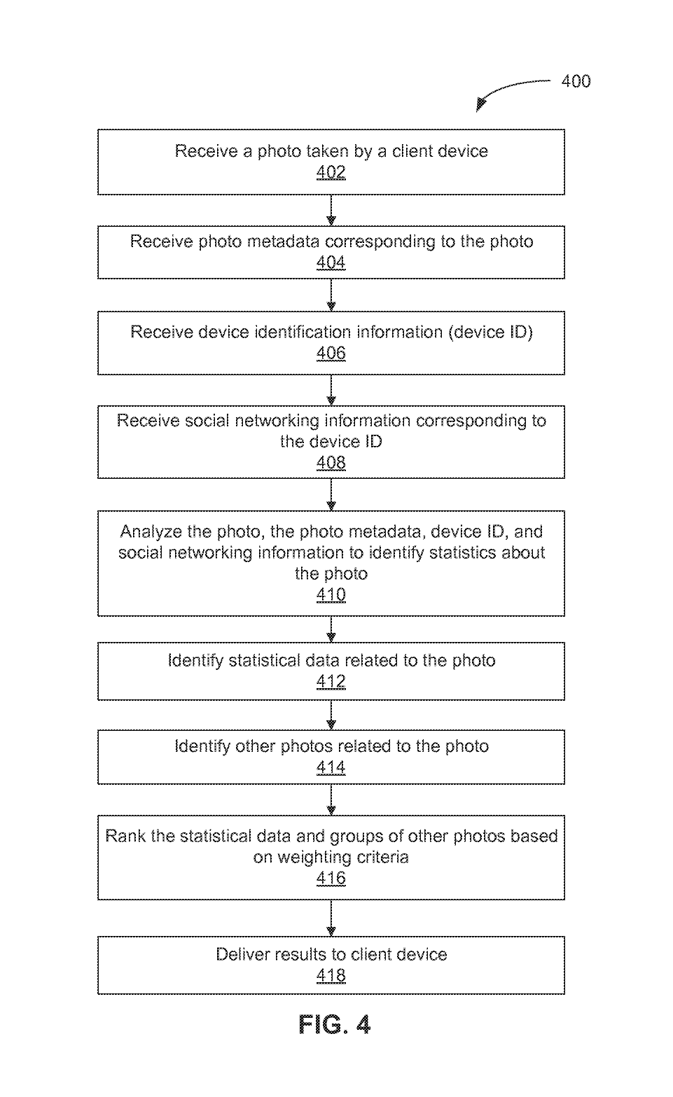

FIG. 4 is a flow diagram for generating one or more photo analytics, according to an example embodiment. Persons skilled in the art will understand that even though the method 400 is described in conjunction with the systems of FIGS. 1-3, any system configured to perform the method stages is within the scope of embodiments of the disclosure.

As shown, the method 400 begins at stage 402 where a server receives a photo taken by a client device. In one embodiment, the client device is a mobile phone and the photo is stored in a photo database.

At stage 404, the server receives photo metadata corresponding to the photo. Examples of metadata include GPS (global positioning system) location information about where the photo is taken, orientation/directional information, camera make/model, orientation of the camera (i.e., horizontal/vertical), date/time, weather data (e.g., sunset/sunrise info, direction of light, weather conditions), post-processing filters, contrast, brightness, flash ON/OFF, exposure level, number of faces in the photo, among others. In some embodiments, the metadata corresponding to the photo is included as part of the same file as the image of the photo.

At stage 406, the server receives device identification information (device ID) associated with the client device that captured the photo. In some embodiments, each client device is associated with a particular user. At stage 408, the server receives social networking information corresponding to the device ID. In embodiments where the device ID is associated with a user, the social networking information provides a listing of other users with which the user/client device is associated, e.g., as “friends,” or “followers,” and/or as being within the same social “circle.”

At stage 410, the server analyzes the photo, the photo metadata, the device ID, and the social networking information to identify one or more statistics about the photo.

According to various embodiments, the analyzing may include performing facial recognition, landmark recognition, or any other image analysis on the photo. Furthermore, according to various embodiments, the analyzing may include analyzing determining how many other people have taken a photo in this location (and what were their demographics, age, gender, interests, etc.), which people in the user's social network or contacts list have taken a photo in this location, if there are people in the user's social network that have taken photos here: who were they with, when were they here, what were their photos like (option to access the photos if they have been made public), what were other similar photo locations of people who took photos here (either all users or just people in the user's circles), what were the preferred camera settings of people who took a photo in this location, what was the preferred photo orientation of people who took a photo in this location, what was the most common time of day that users took a photo in this location.

According to some embodiments, users can set privacy settings that limit, restrict, or remove their photos and/or photo metadata from being shared with others and/or used by the analytics engine to perform photo analysis. For example, a first user may choose to only allow the analytics engine to use the first user's photos and metadata when analyzing photos of a second user, when the second user is directly connected to the first user. In another example, the metadata of the photos of the first user may be used by the analytics engine when analyzing all photos of other users, but the photos themselves of the first user may only be available to the analytics engine for photos taken by users that are directly connected to the first user.

At stage 412, the server identifies statistical data related to the photo. In some examples, the statistical data includes a numerical count or numerical percentage related to a parameter of the photo. For example, the statistical data may indicate the number of users that have taken a photo in this location or the percentage of users that have taken a photo in this location in landscape orientation versus portrait orientation. In some embodiments, certain photos taken by others may be taken into consideration when calculating the statistical data, although the photos themselves are not available to the user of the client device that has taken the photo being analyzed by the analytics engine.

At stage 414, the server identifies other photos related to the photo. The other photos may be organized in groups, such as by same location, same location and orientation, same location but different orientation, etc. As described above, the other photos are available based permissions associated with the photos. Also, in some embodiments, some related photos may be available to the public at large (e.g., photos from professional photographers). In this particular scenario, the user of the client device may not have a social networking relationship with the user that created the publicly-accessible photo, yet the photo is still used by the analytics engine when the analytics engine performs an analysis.

At stage 416, the server ranks the statistical data and groups of other photos based on weighting criteria. For example, statistical data and/or groups of other photos that are based on what the social networking friends of the user of the client device may be weighted higher than “universal” statistical data and/or groups of other photos (e.g., percentage of total number of photos taken at this location at this time of day). In some embodiments, stage 416 is optional and is omitted.

At stage 418, the server delivers the statistical data and the groups of other photos to the client device. The statistical data and the groups of other photos are delivered via a network to the camera software application executing on the client device. The camera software application is configured to cause the statistical data and the groups of other photos to be displayed in a user interface on the client device. In some embodiments, although a particular photo may be used in the calculation of statistics (i.e., stage 412) and/or related photo analysis (i.e., stage 414), the photo may not be available to the user of the client device based on certain permissions set by the user who captured the particular photo.

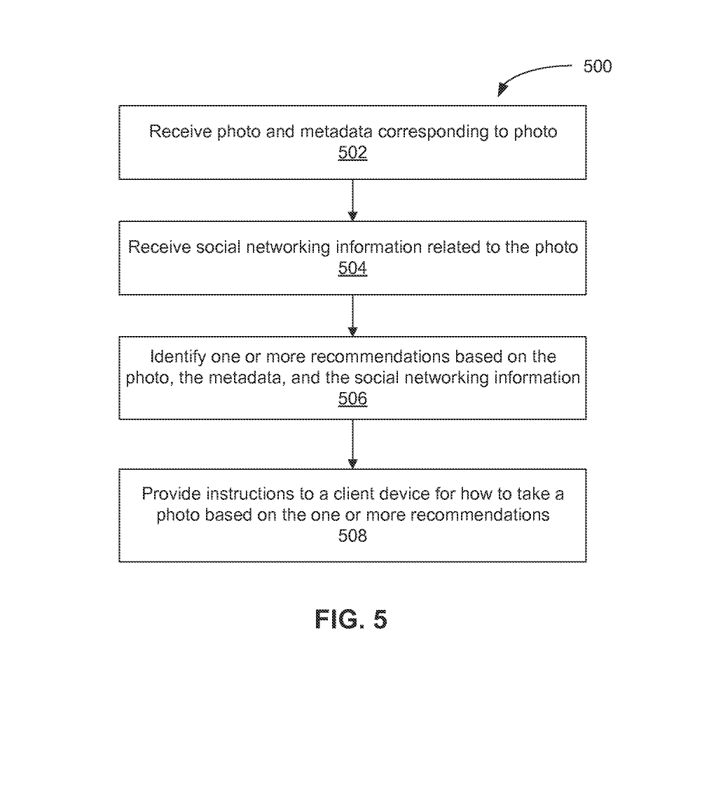

FIG. 5 is a flow diagram for generating one or more photo recommendations, according to an example embodiment. Persons skilled in the art will understand that even though the method 500 is described in conjunction with the systems of FIGS. 1-3, any system configured to perform the method stages is within the scope of embodiments of the disclosure.

As shown, the method 500 begins at stage 502 where a server receives a photo and metadata corresponding to the photo captured by a client device. At stage 504, a server receives social networking information related to the photo. In some embodiments, stages 502 and 504 in FIG. 5 are substantially similar to stages 402/404 and 408 in FIG. 4, respectively.

At stage 506, a server identifies one or more recommendations based on the photo, the metadata, and the social networking information. As an example, suppose that 80% of users have taken photos at this location in the landscape orientation. However, the user of the client device captured the photo in the portrait orientation. The server may identify that the many other users (i.e., 80% of users) have taken a photo at this location, but in a different orientation from the photo captured by the client device. The recommendation can then be provided to the client device as an alert or notification.

At stage 508, a server provides instructions to the client device for how to take a photo based on the one or more recommendations. For example, if 75% of users have taken a photo of the same landmark, but from a location 500 feet to the east of the current location of the photo, the recommendation may include an indication that many other users (i.e., 75% of users) have taken a photo at a location 500 feet to the east. In some embodiments, the recommendation also includes instructions on how to perform and/or complete the recommendation. For example, the recommendation includes instructions on how to reach the location 500 feet to the east.

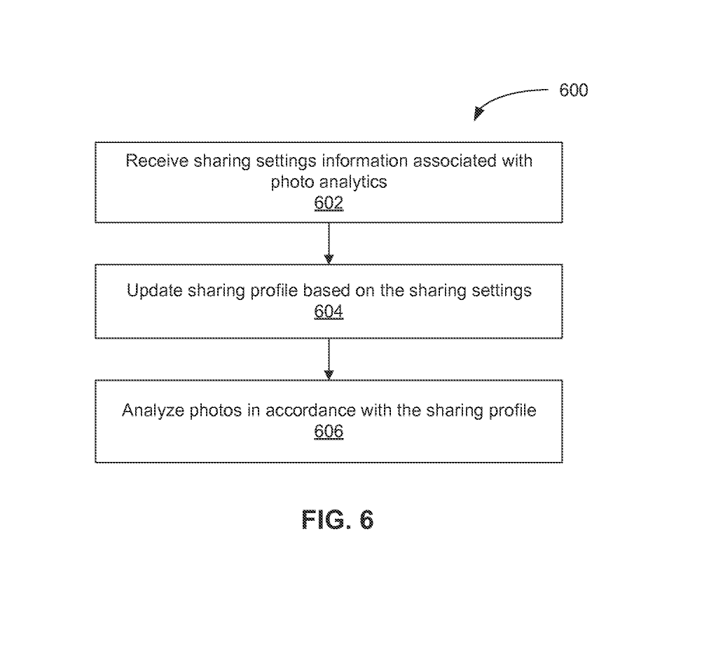

FIG. 6 is a flow diagram for updating photo analytics settings, according to an example embodiment. Persons skilled in the art will understand that even though the method 600 is described in conjunction with the systems of FIGS. 1-3, any system configured to perform the method stages is within the scope of embodiments of the disclosure.

As shown, the method 600 begins at stage 602 where a server receives sharing settings information associated with photo analytics. The sharing settings may identify which data and/or photos are to be used by the analytics engine when computing photo analytics for which other users' photos. Examples of settings include: which photos are to be shared with others, with which other users the photos are to be shared, which particular pieces of metadata are to be shared and with whom, etc.

At stage 604, the server updates a sharing profile based on the sharing settings. In one embodiment, each user is associated with a sharing profile that identifies which data and/or photos is to be used by the analytics engine when computing photo analytics. In other embodiments, the sharing settings are not stored at the user-level, but rather on a photo-by-photo basis. At stage 606, the server analyzes photos in accordance with the sharing profile. As described, only the data and/or photos that are within the appropriate permissions are used by the server to perform the analysis. Moreover, the user can change their permissions at any time. The update is then propagated on the server.

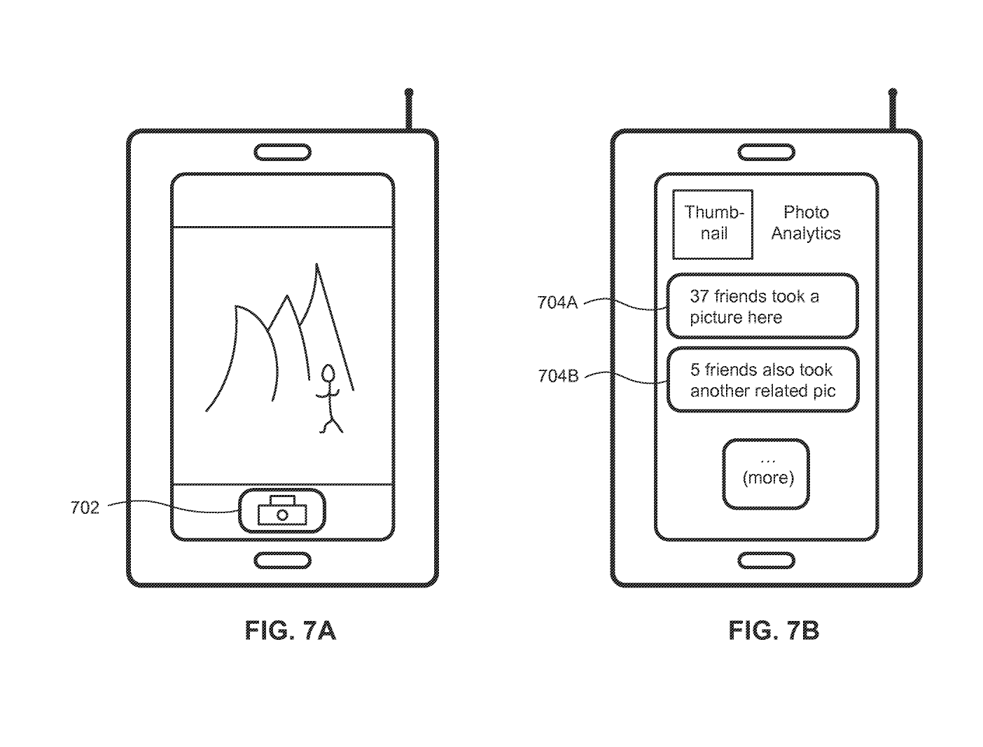

FIGS. 7A-7B are conceptual diagrams illustrating a user interface for presenting one or more analytics about a photo, according to an example embodiment. As shown in FIG. 7A, a client device can capture a photo of a scene when a user selects a “take photo” button 702 included in the camera software. In response, the camera software transmits the photo and/or metadata corresponding to the photo to a server and/or photo database. The server performs photo analytics, in accordance with the description above, and returns photo analytics results to the client device.

FIG. 7B is an example of a user interface of photo analytics results returned to the client device. As shown, icons 704A, 704B present statistics in the user interface. An icon 706 indicates that more statistics are available to be viewed (e.g., by scrolling down). A user of the client device can select on one of the icons 704, 704B to view more detailed information corresponding to that particular statistic.

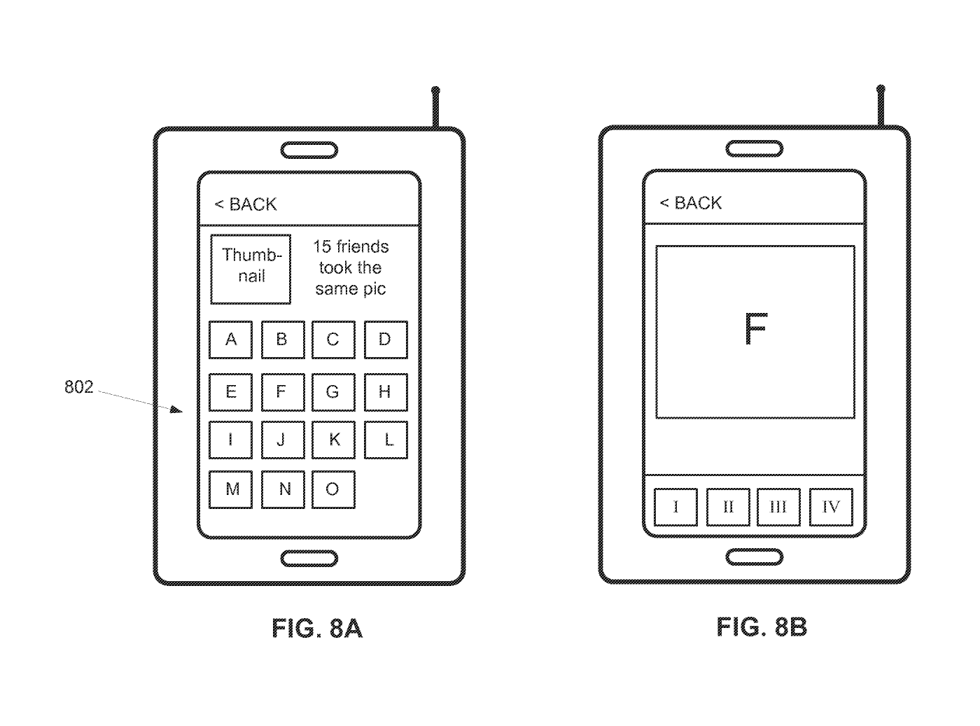

FIGS. 8A-8B are conceptual diagrams illustrating a user interface for presenting one or more recommendations associated with a photo, according to an example embodiment. In one example, the user interface shown in FIG. 8A is presented after a user selects one of the statistics and/or results presented in FIG. 7B. In the example in FIG. 8A, the user interface indicates that 15 friends of the user have also taken a photo at the same location. Thumbnails 802 of the photos from the friends may also be displayed in the user interface. In one example, if the user selects one of the thumbnails 804, the client device displays the user interface shown in FIG. 8B.

In the example shown, the user has selected the thumbnail labeled thumbnail “F.” A full-screen version of the photo is displayed in FIG. 8B. In addition, options I, II, III, and IV are displayed below the full-screen version of the photo. The options I-IV may correspond to recommendations to the user that are related to the selected photo labeled thumbnail “F.” For example, option I may correspond to a recommendation to take a photo with same camera orientation setting as the photo labeled thumbnail “F,” option II may correspond to a recommendation to take a photo with same contrast and brightness setting as the photo labeled thumbnail “F,” option III may correspond to a link to view photos related to the photo labeled thumbnail “F,” and option IV may correspond to a link to view the other photos taken by the user who took the photo labeled thumbnail “F.”

Advantageously, embodiments of the disclosure provide a system and method for providing camera photo analytics to a user. Since the analytics are provided to the user in real-time (i.e., immediately or shortly after the photo has been captured), the user is likely still at the location in which the photo was captured. The user can then determine which other photos to take, whether the photo should be re-taken, or learn other interesting things about the photos of others, making the overall picture-taking experience more enjoyable and worthwhile.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to retrieve content (i.e., recorded voicemails) from a content server (i.e., a voicemail server). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as, for example, to a city, ZIP code, or state level), so that a particular location of a user cannot be determined. Thus, the user may have control over how information is collected about him or her and used by the systems discussed herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the disclosed subject matter (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or example language (e.g., “such as”) provided herein, is intended merely to better illuminate the disclosed subject matter and does not pose a limitation on the scope of the invention unless otherwise claimed. No language in the specification should be construed as indicating any non-claimed element as essential to the practice of the invention.

Variations of the embodiments disclosed herein may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for generating one or more statistics related to a photo, comprising:
collecting information describing circumstances of an event resulting in creation of a first photo taken by a camera;
associating the information with the first photo, wherein the information includes attributes of an image included in the first photo and the camera;
analyzing the information with respect to social networking information stored in one or more databases; and
identifying one or more other photos related to the first photo based on results of the analysis.

2. A method according to claim 1, further comprising generating one or more statistics related to the one or more other photos.

3. A method according to claim 2, further comprising delivering the statistics to a client device, wherein the statistics are displayed in a user interface on the client device.

4. A method according to claim 1, wherein the information includes one or more of GPS location information related to where the first photo is taken, orientation and/or directional information of the camera, a make and/or model of the camera, a date and/or time of the first photo, weather data at the time the first photo is taken, post-processing filters applied to the first photo, contrast and/or brightness of the first photo, whether flash on the camera is ON/OFF when the first photo is taken, and exposure level of the first photo, and number of faces in the photo.

5. A method according to claim 1, wherein the social networking information includes one or more of related users that are friends with a user corresponding to the camera, one or more related photos that the related users have taken that are similar to the first photo, and other photos the related users have taken before and after the related photo.

6. A method according to claim 1, wherein the one or more photos are related to one or more of how many other users have taken a photo in the same location, which friends have taken a photo in the same location, what are other similar photo locations of users who took photos in the same location, what are the preferred camera settings of users who took a photo in the same location, what is the preferred photo orientation of users who took a photo in the same location, and what is the most common time of day that users took a photo in the same location.

7. A method according to claim 1, further comprising providing instructions on how to take a photo similar to the one or more other photos related to the first photo.

8. A method according to claim 1, further comprising analyzing sharing permissions of the first photo and the information.

9. A method for receiving one or more statistics related to a photo, comprising:
capturing a first photo with a camera;
generating metadata corresponding to the first photo;
transmitting the first photo and the metadata to a server that includes an analytics engine; and
receiving, from the server, statistical information related to the first photo, wherein the statistical information is generated based on the analytics engine analyzing the first photo and the metadata with respect to social networking information stored in a database.

10. A method according to claim 9, wherein the statistical information includes one or more photos related to the first photo.

11. A method according to claim 9, wherein the first photo is captured by a mobile device configured to communicate with the server via a data network.

12. A system for generating a statistic about a photo, comprising:
one or more databases storing photos and social networking data;
a mobile phone that includes a camera configured to take a first photo;
a server in communication with the mobile phone via a data network configured to:
receive the first photo taken by the camera;
receive metadata corresponding to the first photo and device information corresponding to the mobile phone;
analyze the first photo, the metadata, and the device information with respect to the social networking data stored in the one or more databases; and
identify one or more photos related to the first photo based on analyzing the first photo, the metadata, and the device information.

13. A system according to claim 12, wherein the server is further configured to generate one or more statistics related to the one or more photos

14. A system according to claim 13, wherein the server is further configured to deliver the statistics to the client mobile phone via the data network.

15. A system according to claim 13, wherein the data network comprises a cellular data network and/or the internet.

16. A system according to claim 12, wherein the metadata includes one or more of GPS location information related to where the first photo is taken, orientation and/or directional information of the camera, a make and/or model of the camera, a date and/or time of the first photo, weather data at the time the first photo is taken, post-processing filters applied to the first photo, contrast and/or brightness of the first photo, whether flash on the camera is ON/OFF when the first photo is taken, and exposure level of the first photo, and number of faces in the photo.

17. A system according to claim 12, wherein the social networking information includes one or more of related users that are friends with a user corresponding to the device information, one or more related photos that the related users have taken that are similar to the first photo, and other photos the related users have taken before and after the related photo.

18. A system according to claim 12, wherein the one or more photos are related to one or more of how many other users have taken a photo in the same location, which friends have taken a photo in the same location, what are other similar photo locations of users who took photos in the same location, what are the preferred camera settings of users who took a photo in the same location, what is the preferred photo orientation of users who took a photo in the same location, and what is the most common time of day that users took a photo in the same location.

19. A system according to claim 12, wherein the server is further configured to provide instructions to the client device on how to take a photo similar to the one or more photos related to the first photo.

20. A system according to claim 12, wherein the server is further configured to analyze share permissions of the first photo and the metadata.
